(19) United States
(12) Patent Application Publication
(10) Pub. No.: US 2026/0130315 A1
(43) Pub. Date: May 14, 2026

(54) Eco-Friendly and Plantable Paper Products and Writing Utensil

(71) Applicants: Jinal Amin, Jacksonville, FL (US); Meena Amin, Jacksonville, FL (US)

(72) Inventors: Jinal Amin, Jacksonville, FL (US); Meena Amin, Jacksonville, FL (US)

(21) Appl. No.: 19/032,168

(22) Filed: Jan. 20, 2025

Related U.S. Application Data
(60) Provisional application No. 63/557,721, filed on Feb. 26, 2024.

(51) Int. Cl. A01C 1/04

(52) U.S. Cl. CPC A01C 1/044

(57) ABSTRACT

An eco-friendly paper product and writing utensil system designed for environmental sustainability. The paper product includes embedded seeds of various types, such as wildflower, herb, and/or vegetable. The seeds are dried and flattened to produce customizable plantable paper suitable for a range of products like notecards, business cards, and bookmarks. In one embodiment, an eco-friendly writing utensil made from recyclable materials is disclosed. The writing utensil includes newspaper and kraft paper, features a plantable capsule with seeds at one end, enabling the writing utensil to be planted post-use to grow a plant.

### CROSS-REFERENCE TO RELATED APPLICATION

The present application claims priority to, and the benefit of, U.S. Provisional Application No. 63/557,721, which was filed on Feb. 26, 2024, and is incorporated herein by reference in its entirety.

### FIELD OF THE INVENTION

The present invention generally relates to the field of eco-friendly stationery items. More specifically, the present invention relates to novel paper products and writing utensils that can be planted after use. Plantable paper is paper made from recycled pulp paper and seeds that can be used to create a wide variety of items, such as calendars, notebooks, cards, and more. Writing utensils host a capsule with seeds therein that can be planted when the utensil can no longer be used. The paper and writing utensil help individuals grow organic and fresh vegetables, flowers, and other plants at home. Accordingly, the present disclosure makes specific reference thereto. Nonetheless, it is to be appreciated that aspects of the present invention are also equally applicable to other like applications, devices, and methods of manufacture.

### BACKGROUND

By way of background area, paper production has heavily relied on the use of wood pulp derived from cutting down trees in natural forests. Paper production contributes to deforestation which is a major environmental issue. Deforestation also leads to the loss of biodiversity as animal and plant habitats are destroyed, and also disrupts local ecosystems. Trees play a crucial role in carbon sequestration and they absorb carbon dioxide from the atmosphere. Removing trees for paper production contributes to increased levels of greenhouse gases, exacerbating global warming.

While recycling and the use of post-consumer waste in paper production have increased in recent times, however the challenges of environmentally friendly processes exist. The recycling process itself can be energy-intensive, and not all paper products are recyclable. Moreover, there is currently no widespread, effective method to “plant” used paper products in a manner that directly benefits the environment, such as biodegradation into beneficial substances or transformation into new, valuable natural resources.

Also, most pens are made from plastic, a petroleum-based product, and are disposed of after use. The production of plastic pens involves the extraction and processing of crude oil, which is energy-intensive and polluting. Once discarded, such pens often end up in landfills or oceans, where they can take hundreds of years to degrade, releasing toxic substances and contributing to plastic pollution. The wood for pencils typically comes from trees, which, if not sustainably sourced, contributes to deforestation. Individuals desire improved writing utensils that provide environmentally beneficial solutions such as transforming into a new plant.

Therefore, there exists a long felt need in the art for sustainable paper products and writing instruments that can be used for growing organic and fresh vegetables, flowers, and other plants. There is also a long felt need in the art for sustainable paper products that are made from pulp paper that are embedded with a variety of seed types. Additionally, there is a long felt need in the art for a novel paper product and writing utensil that can be planted in the ground or within a pot after use for transforming into a plant. Moreover, there is a long felt need in the art for a novel recyclable pen that replaces standard plastic pens and helps reduce global warming related to deforestation. Further, there is a long felt need in the art for an improved writing utensil that has a cap or capsule that can be filled with seeds for planting when the utensil is finished being used. Furthermore, there is a long felt need in the art for novel sustainable paper products, including calendars, notebooks, and business cards that can be planted instead of discarded after use. Finally, there is a long felt need in the art for sustainable and eco-friendly plantable paper products and writing utensils that reduce global warming and can be planted to provide plants after use.

The subject matter disclosed and claimed herein, in one embodiment thereof, comprises an eco-friendly paper product and writing utensil system. The system includes a plantable paper product that has embedded seeds of various types, such as wildflower, herb, or vegetable. The paper product is suitable for a range of products like notecards, business cards, and bookmarks. The eco-friendly writing utensil is made from recyclable materials, including newspaper and kraft paper, features a plantable capsule with seeds at one end, enabling the utensil to be planted post-use to grow a plant. The seeds of the paper product and the writing utensil germinate to form a plant in about 8-15 days.

In this manner, the eco-friendly paper product and writing utensil of the present invention accomplish all of the forgoing objectives and provide users a line of sustainable paper products, including calendars, notebooks, and business cards that can be planted instead of discarded. The products enable a user to plant the items in the ground or within a pot after use to germinate and transform into plants. The writing utensil replaces standard plastic pens and helps reduce global warming related to deforestation. The paper product and writing utensil help individuals grow organic and fresh vegetables, flowers, and other plants at home.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a method for producing eco-friendly paper that can be planted. The method comprises the steps of procuring raw paper and sanitizing the raw paper to remove contaminants. Then, water, hydrogen peroxide, and sodium hydroxide are added to the sanitized paper to break down the paper into fibers and form recycled paper pulp. Then, the recycled paper pulp is subjected to ink removing chemicals to produce pure and white recycled paper pulp. Then, different types of seeds are mixed with the pulp for uniform blending and finally, the mixture is dried and flattened to form plantable paper capable of being printed for various uses and customizations.

In another aspect, a plantable paper product is disclosed. The paper is designed to be planted in a pot or ground to transform into a plant. The paper includes a planar recyclable paper structure with a plurality of embedded seeds, wherein the paper can include any seeds to accommodate user preferences, and can have any design, color, and size. The paper is usable for creating a variety of paper product lines including notecards, business cards, invitations, bookmarks, calendars, tags, flags, postcards, and more, wherein the plantable paper comes in different weight variants to meet various user preferences.

In yet another aspect, an eco-friendly plantable notebook made from plantable paper is disclosed. The notebook comprises a plurality of customized or blank plantable paper pages, a biodegradable and plantable binding used for the notebook's assembly, wherein each paper and the binding are capable of being used for planting, thereby enabling the entire notebook to contribute to plant growth post-use.

In yet another embodiment, an eco-friendly writing utensil is disclosed. The writing utensil comprises a body made of recyclable material including newspaper, kraft paper, and recycled paper, a writing lead enclosed by the recyclable body, a plantable capsule disposed at the bottom end of the utensil, which includes embedded seeds and is made of biodegradable material, wherein the writing utensil can be planted after use to grow a new plant from the embedded seeds.

In a further embodiment, the eco-friendly writing utensil is packaged in a biodegradable and plantable packaging. The packaging accommodates a set of writing utensils ranging from 2 to 50 units and includes an indicia on the front surface indicating the type and nature of the enclosed writing utensils, instructions on the rear surface for disposing of the writing utensils to facilitate plant growth, wherein the writing utensils contained within include a variety of seeds in their plantable capsules and come in different colors, shapes, sizes, and materials to accommodate user preferences.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a flow chart depicting a process of making plantable paper of one embodiment of the present invention in accordance with the disclosed structure;

FIG. 2 illustrates a perspective view of an exemplary plantable paper in accordance with one embodiment of the present invention;

FIG. 3 illustrates an exemplary plantable notebook made from the plantable paper of the present invention in accordance with one embodiment of the present invention;

FIG. 4 illustrates a flow diagram depicting a process of use of the plantable paper for growing a plant in accordance with one embodiment of the present invention;

FIG. 5 illustrates a perspective view of an eco-friendly writing utensil of the present invention in accordance with one embodiment of the present invention;

FIG. 6 illustrates a perspective view showing the eco-friendly writing utensil planted in a pot for growing a plant in accordance with one embodiment of the present invention;

FIG. 7 illustrates an exemplary packaging of the writing utensils of the present invention in accordance with the disclosed structure; and

FIG. 8 illustrates another embodiment of the writing utensil of the present invention in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for sustainable paper products and writing instruments that can be used for growing organic and fresh vegetables, flowers, and other plants. There is also a long felt need in the art for sustainable paper products that are made from pulp paper that are embedded with a variety of seed types. Additionally, there is a long felt need in the art for a novel paper product and writing utensil that can be planted in the ground or within a pot after use for transforming into a plant. Moreover, there is a long felt need in the art for a novel recyclable pen that replaces standard plastic pens and helps reduce global warming related to deforestation. Further, there is a long felt need in the art for an improved writing utensil that has a cap or capsule that can be filled with seeds for planting when the utensil is finished being used. Furthermore, there is a long felt need in the art for novel sustainable paper products, including calendars, notebooks, and business cards that can be planted instead of discarded after use. Finally, there is a long felt need in the art for sustainable and eco-friendly plantable paper products and writing utensils that reduce global warming and can be planted to provide plants after use.

The present invention, in one exemplary embodiment, is an eco-friendly writing utensil. The writing utensil comprises a body made of recyclable material including newspaper, kraft paper, and recycled paper, a writing lead enclosed by the recyclable body, a plantable capsule disposed at the bottom end of the utensil, which includes embedded seeds and is made of biodegradable material, wherein the writing utensil can be planted after use to grow a new plant from the embedded seeds.

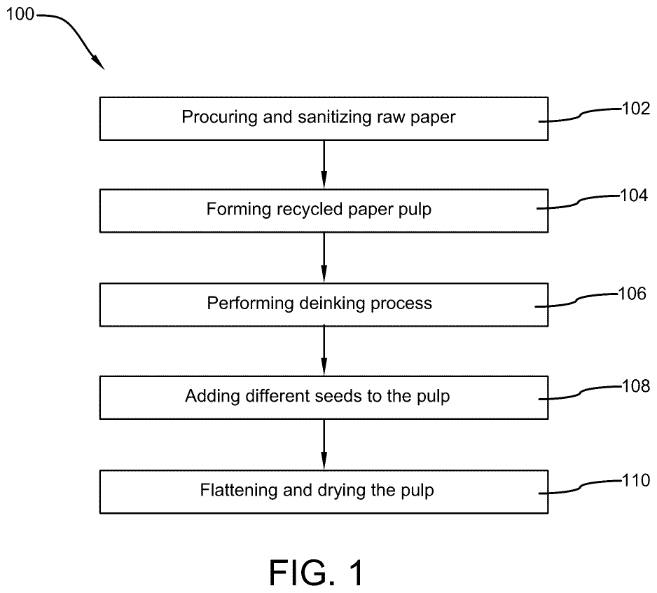

Referring initially to the drawings, FIG. 1 illustrates a flow chart depicting a process of making plantable paper of one embodiment of the present invention in accordance with the disclosed structure. In the method 100 for making the plantable paper, initially, raw paper is procured and is sanitized for removing contaminants (Step 102). Then, water, hydrogen peroxide, and sodium hydroxide are added to the sanitized paper to further break down the paper into paper fibers to form the recycled paper pulp (Step 104). The recycled paper pulp is then subjected to ink removing chemicals to remove ink, dyes, and more for providing pure and white recycled paper pulp (Step 106). Thereafter, the different seeds are mixed with the pulp for uniform blending of seeds in the pulp (Step 108). Depending on the preferences of users, any type of seeds such as wildflower, herb, or vegetable seeds can be added to the pulp. Finally, the mixture of the above step is dried and flattened to form the plantable paper which can be printed for different uses and customization (Step 110).

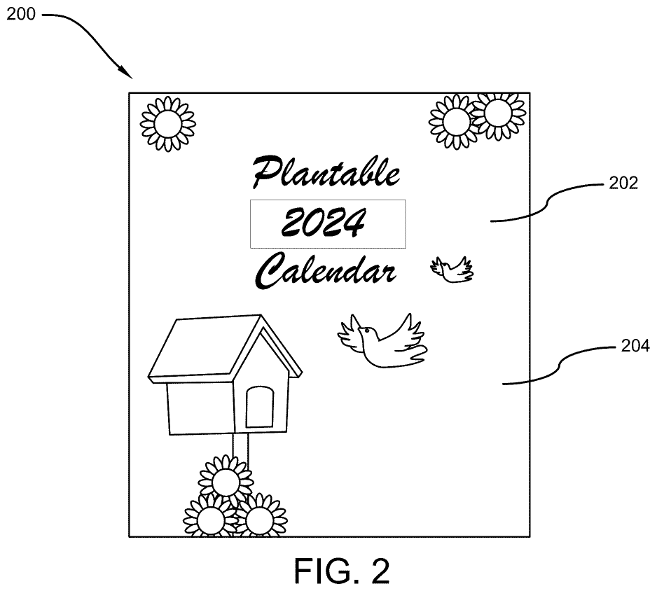

FIG. 2 illustrates a perspective view of an exemplary plantable paper in accordance with one embodiment of the present invention. As illustrated, the plantable paper 200 includes a planar recyclable paper 202 which includes a plurality of embedded seeds 204. The plantable paper 200 can include any seeds to accommodate user preferences. The paper 200 can have any design, color, and size. The eco-friendly paper 200 of the present invention can be used for making paper product lines including but not limited to notecards, business cards, invitations, bookmarks, calendars, tags, flags, postcards, and more. The eco-friendly plantable paper 200 can come in different variants such as 130 GSM, 150 GSM, 180 GSM, 200 GSM, and 250 GSM. In some embodiments, the paper 200 can range from about 100 GSM to about 350 GSM to meet different user preferences.

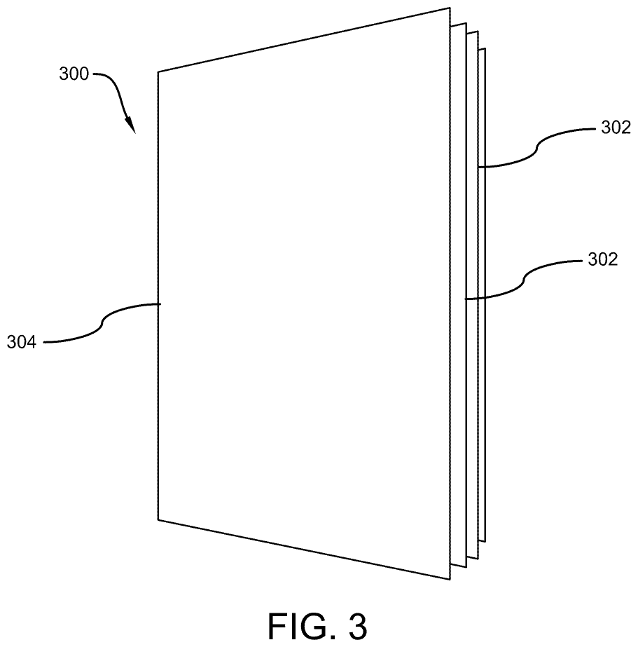

FIG. 3 illustrates an exemplary plantable notebook made from the plantable paper of the present invention in accordance with one embodiment of the present invention. As illustrated, the plantable notebook 300 is made from a plurality of customized or blank plantable papers or pages 302. Further, the plantable notebook 300 can be bound using a biodegradable and plantable binding 304 that can also be used for planting. The printing ink on the notebook 300 is toxin-free and is made of biodegradable materials that do not obstruct the planting process of the paper products.

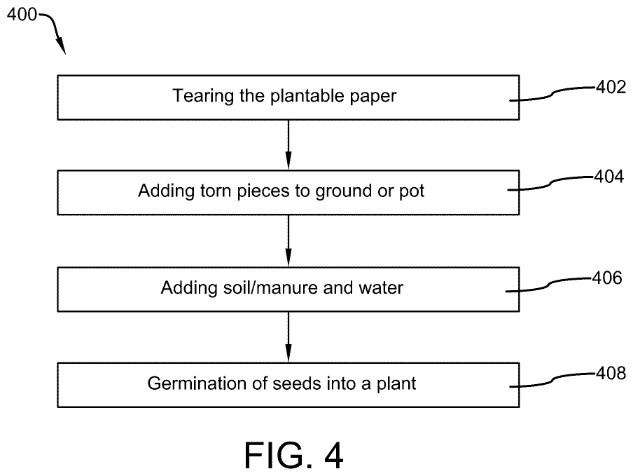

FIG. 4 illustrates a flow diagram depicting a process of use of the plantable paper for growing a plant in accordance with one embodiment of the present invention. Initially, a plantable paper is cut or torn into a plurality of small pieces (Step 402) wherein the size and shape can vary depending on the shape of the plantable paper. Then, the torn pieces are added to a container, tray, pot, soil area, ground area, or in any other container in which the plant is to be grown (Step 404). Thereafter, water is added to the container to soak the paper pieces and soil/manure/fertilizers are added to the container (Step 406). After a few days, such as 7-10 days, the embedded seeds in the paper sprout to grow to a corresponding plant (Step 408).

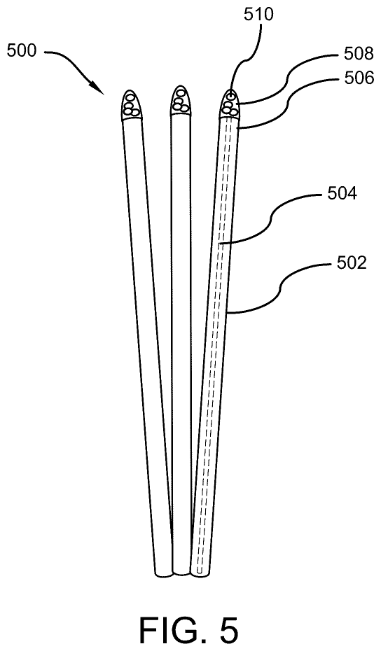

FIG. 5 illustrates a perspective view of an eco-friendly writing utensil of the present invention in accordance with one embodiment of the present invention. The eco-friendly writing utensil 500 is made of a recyclable material 502 which is combination of a newspaper, brown and white kraft paper, and recycled paper. The writing utensil 500 includes a writing lead 504 covered by the recyclable material 502 and the writing lead 504 is used for writing on any conventional paper and plantable paper 100.

An eco-friendly and plantable capsule 506 is disposed at the bottom or top end 508 of the plantable writing utensil 500. The capsule 506 includes embedded seeds 510 and the writing utensil 500 can be planted with the bottom end 508 for growing a new plant from the writing utensil 500. The capsule 506 is made of a biodegradable material and permeates to release seeds.

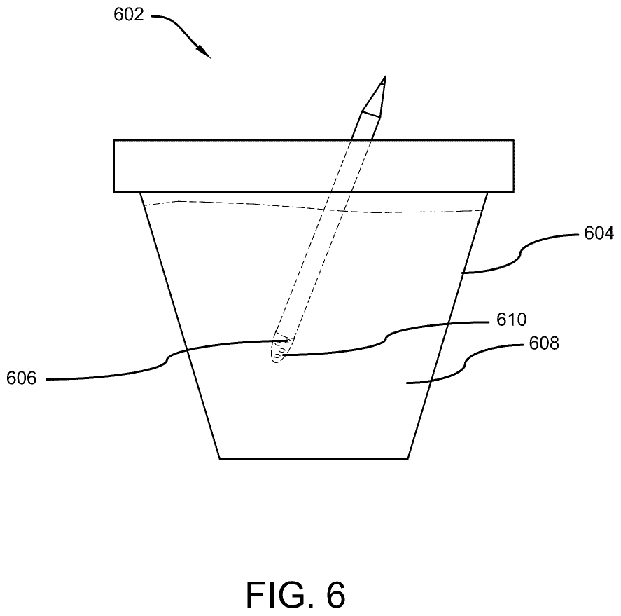

FIG. 6 illustrates a perspective view showing the eco-friendly writing utensil planted in a pot for growing a plant in accordance with one embodiment of the present invention. The advantage of the writing utensil 500 is that the utensil 500 can be planted after use or when no longer is required to be used. As illustrated, a used writing utensil 602 is placed in a pot 604 with seed side 606 inserted in the soil/manure 608 in the pot 604. Then, using water and sun, within 8-15 days, a plant from the seeds 606 included in the capsule 610 is grown from the pot 604.

In some embodiments, the capsule of the writing utensil is integrated to the utensil and alternatively, can be detachably attached thereto. The writing utensil can come in ink of any color to accommodate user preferences.

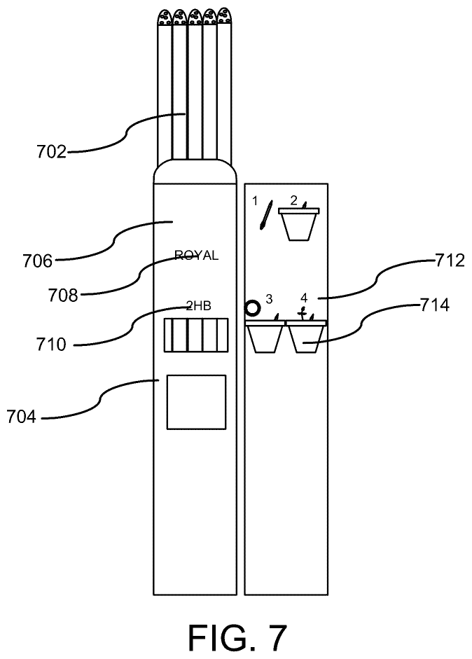

FIG. 7 illustrates an exemplary packaging of the writing utensils of the present invention in accordance with the disclosed structure. The writing utensil 702 can come in a biodegradable and plantable packaging 704 and can come in a bunch of 2-50 utensils. The front surface 706 of the packaging 704 includes a logo or indicia 708 and the type 710 of the writing utensil included in the packaging 704. The rear surface 712 of the packaging 704 can include instructions 714 for disposing of the writing utensil 702 for growing a plant. The writing utensil can come in different colors, shapes, sizes, and materials. Further, any type of seeds can be included in the capsule of the writing utensil.

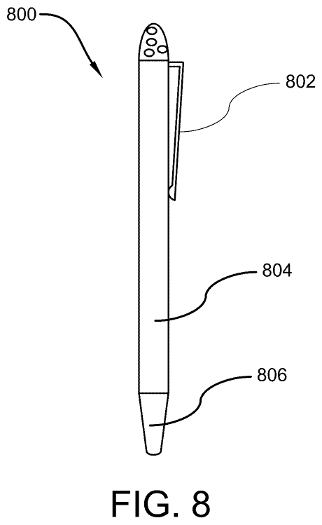

FIG. 8 illustrates another embodiment of the writing utensil of the present invention in accordance with the disclosed structure. In the present embodiment, the writing utensil 800 is in the form of a ball pen and includes at least 75% recycled components. The utensil 800 can include a recyclable cap 802 and the recyclable body 804 may include embedded seeds. The bottom cap 806 can also include embedded seeds for helping grow a plant from the writing utensil 800.

It will be noted that different paper products and the writing utensils can be commercially available in the form of a system for providing eco-friendly solutions and products.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “plantable paper”, “eco-friendly plantable paper”, and “eco-friendly paper” are interchangeable and refer to the eco-friendly plantable paper 200 of the present invention. Similarly, as used herein “eco-friendly writing utensil”, “plantable writing utensil”, and “writing utensil” are interchangeable and refer to the eco-friendly plantable writing utensil 500, 702, 800 of the present invention.

Notwithstanding the forgoing, the eco-friendly plantable paper 200 and eco-friendly plantable writing utensil 500, 702, 800 of the present invention can be of any suitable size and configuration as is known in the art without affecting the overall concept of the invention, provided that it accomplishes the above stated objectives. One of ordinary skill in the art will appreciate that the eco-friendly plantable paper 200 and eco-friendly plantable writing utensil 500, 702, 800 as shown in the FIGS. are for illustrative purposes only, and that many other sizes and shapes of the eco-friendly plantable paper 200 and eco-friendly plantable writing utensil 500, 702, 800 are well within the scope of the present disclosure. Although the dimensions of the eco-friendly plantable paper 200 and eco-friendly plantable writing utensil 500, 702, 800 are important design parameters for user convenience, the eco-friendly plantable paper 200 and eco-friendly plantable writing utensil 500, 702, 800 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A plantable paper product comprising:
a plantable paper;
a plurality of seeds; and
printing ink;
wherein said plantable paper is plantable in the ground;
wherein said printing ink is a toxin free ink;
wherein said plurality of seeds are embedded into said plantable paper; and
wherein said plantable paper selected from the group consisting of a notebook, a notecard, a business card, an invitation, a bookmark, a calendar, a tag, a flag, and a postcard.

2. The plantable paper product of claim 1, wherein said plantable paper have a GSM selected from the group consisting of a 130 GSM, a 150 GSM, a 180 GSM, a 200 GSM, and a 250 GSM.

3. The plantable paper product of claim 1, wherein said plantable paper have a GSM from 100 GSM to 350 GSM.

4. The plantable paper product of claim 3, wherein said plantable paper is planar.

5. The plantable paper product of claim 4, wherein said notebook having a biodegradable binding and a plurality of plantable pages.

6. The plantable paper product of claim 5, wherein said biodegradable binding is plantable.

7. The plantable paper product of clam 6, wherein said toxin-free ink is biodegradable.

8. A method of growing a plant, the method comprising the steps of:
providing a plantable paper, a plurality of seeds, and printing ink, wherein said plantable paper is plantable in a container, wherein said printing ink is a toxin free ink; wherein said plantable paper selected from the group consisting of a notebook, a notecard, a business card, an invitation, a bookmark, a calendar, a tag, a flag, and a postcard;
embedding said plurality of seeds into said plantable paper;
tearing said plantable paper into a plurality of small paper pieces;
placing said plurality of small paper pieces into said container, wherein said container is selected from the group consisting of a tray, a pot, a soil area, and a ground area in which the plant is to be grown;
adding soil to said container; and
adding water to said container.

9. The method of growing the plant of claim 8, further comprising the step of adding fertilizer to said container.

10. The method of growing the plant of claim 8, wherein said plantable paper have a GSM from 100 GSM to 350 GSM.

11. The method of growing the plant of claim 10, wherein said plantable paper is planar.

12. The method of growing the plant of claim 11, wherein said notebook having a biodegradable binding and a plurality of plantable pages.

13. The method of growing the plant of claim 12, wherein said biodegradable binding is plantable.

14. The method of growing the plant of claim 11, wherein said toxin-free ink is biodegradable.

15. A method of making plantable paper pulp for growing a plant, the method comprising the steps of:
procuring raw paper;
sanitizing said raw paper for removing contaminants;
adding water to said sanitized paper;
adding hydrogen peroxide to said sanitized paper;
adding sodium hydroxide to said sanitized paper;
breaking down said sanitized paper into paper fibers;
forming said paper fibers into paper pulp; and
mixing seeds with said paper pulp.

16. The method of making plantable paper pulp for growing a plant of claim 15 further comprising the steps of:
forming said paper pulp around a writing lead; and
forming said paper pulp and said writing lead into a writing instrument, wherein said paper pulp is covered around a writing lead, further wherein said seeds are embedded into a capsule of said writing instrument.

17. The method of making plantable paper pulp for growing a plant of claim 16, wherein said seeds are selected from the group consisting of a wildflower seed, a herb seed, and a vegetable seed.

18. The method of making plantable paper pulp for growing a plant of claim 17, further comprising the step of drying said paper pulp.

19. The method of making plantable paper pulp for growing a plant of claim 18, further comprising the step of flattening said paper pulp into plantable paper.

20. The method of making plantable paper pulp for growing a plant of claim 19, further comprising the steps of:
tearing said plantable paper into a plurality of small paper pieces;
placing said plurality of small paper pieces into a container, wherein said container is selected from the group consisting of a tray, a pot, a soil area, and a ground area in which the plant is to be grown;
adding soil to said container; and
adding water to said container.
